(19) United States
(12) Patent Application Publication
(10) Pub. No.: US 2018/0257246 A1
(43) Pub. Date: Sep. 13, 2018

(54) Joint for an Industrial Robot

(71) Applicant: ABB Schweiz AG, Baden (CH)

(72) Inventor: Mats Olsson, Västerås (SE)

(21) Appl. No.: 15/757,958

(22) PCT Filed: Sep. 7, 2015
(86) PCT No.: PCT/EP2015/070390

§ 371 Date: Mar. 6, 2018

(51) Int. Cl. B25J 17/02; B25J 9/00

(52) U.S. Cl. CPC B25J 17/0258; B25J 9/103; B25J 9/0051

(57) ABSTRACT

A joint for transmitting movements between articulated elements of a parallel kinematics robot has at least two degrees of freedom and includes: a first housing, a second housing arranged rotatable in relation to the first housing about a first axis, and a shaft arranged rotatable in relation to the second housing about a second axis which coincides with a longitudinal axis of the shaft. The shaft is arranged rotatable in relation to the second housing by at least a first angular contact bearing. In applications where one of the revolute pairs of a joint is subjected to radial and axial forces of similar order, and another one is subjected almost solely to radial forces, it is advantageous to manage the forces of the prior by means of an angular contact bearing or bearings configured to bear both radial and axial loads, whereby a joint with very small backlash in a particularly compact design can be achieved.

### TECHNICAL FIELD

The present invention relates to mechanical joints suitable for transmitting movements between articulated elements of parallel kinematics robots.

### BACKGROUND

It is conventionally known to connect articulated elements of parallel kinematics robots with joints having one, two or three degrees of freedom (DOF). For example, US20050129495A1 discloses in FIG. 7a a joint having two or three DOFs depending on configuration. In US20050129495A1 the different DOFs are divided on different bearings, but constructions of the bearings and other elements of the joints are not disclosed in detail. It is also common to use universal ball joints with three DOFs in parallel kinematics robots. U.S. Pat. No. 5,941,128A discloses a joint having two DOFs divided on two respective sets of bearings.

In many parallel kinematics robots the demands on the joints are more or less the same, including low or “zero” backlash, light weight, compactness, large working envelope, robustness, low cost, possible to manufacture in large series, possible to make a sealed “washable” version, etc. It is a challenging task to develop a high quality product meeting all these demands, and there remains a desire to further improve the existing joints.

### SUMMARY

One object of the invention is to provide an improved joint for transmitting movements between articulated elements of a parallel kinematics robot.

One object of the invention is to provide an improved industrial robot.

These objects are achieved by the different aspects of the present invention.

The invention is based on the realization that in certain applications of a joint, especially in robot applications with parallel kinematics robots, one of revolute pairs of the joint is subjected to radial and axial forces of similar order, while another one is subjected almost solely to radial forces.

According to a first aspect of the invention, there is provided a joint for transmitting movements between articulated elements of a parallel kinematics robot. The joint has at least two degrees of freedom and it comprises a first housing, a second housing arranged rotatable in relation to the first housing about a first axis and a shaft arranged rotatable in relation to the second housing about a second axis which coincides with a longitudinal axis of the shaft. The shaft is arranged rotatable in relation to the second housing by means of at least a first angular contact bearing. A joint managing radial and axial forces by means of an angular contact bearing or bearings can be construed to achieve very small backlash in a particularly compact design.

According to one embodiment of the invention the first axis is perpendicular in relation to the second axis.

According to one embodiment of the invention the first axis intersects the second axis.

According to one embodiment of the invention the shaft is arranged rotatable in relation to the second housing by means of a second angular contact bearing configured to bear axial load in opposite direction than the first angular contact bearing.

According to one embodiment of the invention each angular contact bearing comprises a plurality of cylindrical rolling elements.

According to one embodiment of the invention the first housing is formed as a fork comprising two branches, and the second housing is arranged rotatable between the two branches by means of a roller bearing at each branch.

According to one embodiment of the invention each roller bearing is a deep groove ball bearing.

According to one embodiment of the invention the first housing consists of at least two individual parts that are configured to be put together, each of the two branches belonging to a different individual part.

According to one embodiment of the invention at least two of the individual parts are identical.

According to one embodiment of the invention each angular contact bearing is preloaded with a force than has components both in an axial and in radial directions in relation to the second axis.

According to one embodiment of the invention the preload is achieved by means of a screw thread on the shaft.

According to one embodiment of the invention the construction of the joint allows the second housing to rotate about the first axis by at least 220 degrees.

According to one embodiment of the invention the construction of the joint does not limit the rotation of the shaft about the second axis.

According to a second aspect of the invention, there is provided an industrial robot comprising a joint according to any of the embodiments described hereinbefore.

According to one embodiment of the invention the industrial robot is a parallel kinematics robot.

### BRIEF DESCRIPTION OF THE DRAWINGS

The invention will be explained in greater detail with reference to the accompanying drawings, wherein

FIG. 1a shows a cross section of a joint according to one embodiment of the invention,

FIG. 1b shows an isometric view of the cross section of FIG. 1a,

FIG. 2a shows a cross section of a joint according to one embodiment of the invention,

FIG. 2b shows an isometric view of the cross section of FIG. 2a,

FIG. 2c shows an isometric view of the joint of FIG. 2a,

FIG. 3 shows an industrial robot according to one embodiment of the invention,

FIG. 4a shows an isometric view of the joint of FIG. 1a in a first position, and

FIG. 4b shows an isometric view of the joint of FIG. 1a in a second position.

### DETAILED DESCRIPTION

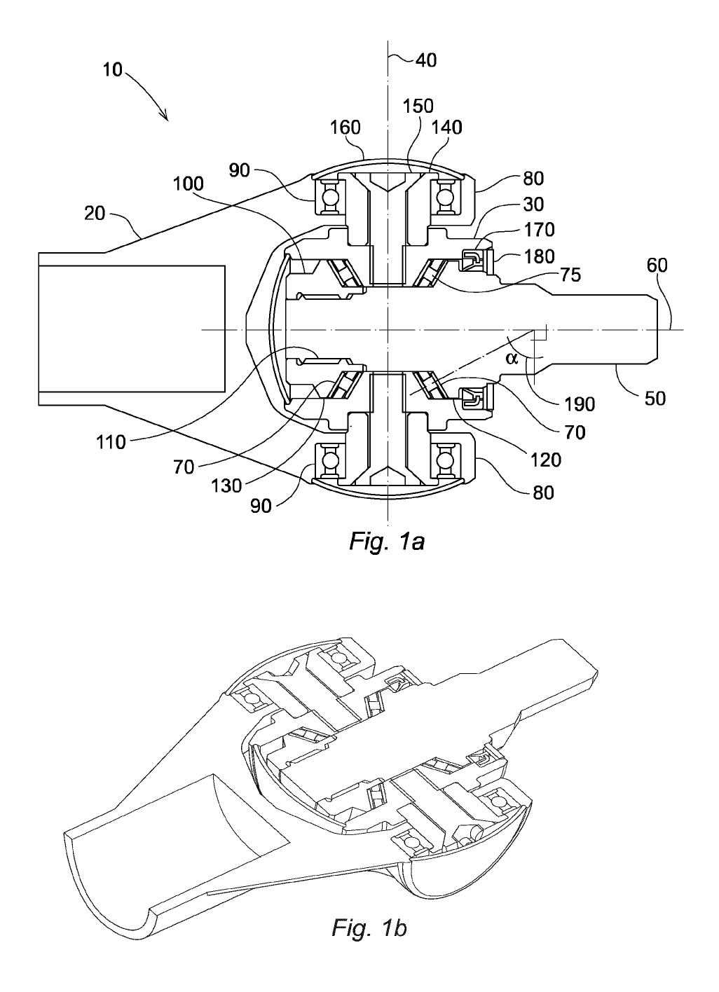

Referring to FIG. 1 a, a joint 10 according to one embodiment of the invention comprises a first housing 20, a second housing 30 arranged rotatable in relation to the first housing 20 about a first axis 40, and a shaft 50 arranged rotatable in relation to the second housing 30 about a second axis 60 which coincides with a longitudinal axis of the shaft 50. The first axis 40 is perpendicular in relation to the second axis 60, and intersects with the same. The construction of the joint 10 allows the second housing 30 to rotate about the first axis 40 by over 220 degrees, and preferably by over 230 degrees, such as by 240 degrees. The construction of the joint 10 does not limit the rotation of the shaft 50 about the second axis 60.

The shaft 50 is arranged rotatable in relation to the second housing 30 by means of two angular contact bearings 70 configured to bear axial load in opposite directions. Each of the two angular contact bearings 70 comprises a plurality of cylindrical rolling elements 75 that are inclined with respect to the second axis 60. A contact angle 190 is defined as an angle between a line joining the points of contact of the rolling elements 75 and bearing raceways in a radial plane, along which the load is transmitted from one raceway to another, and a line perpendicular to the bearing axis (which bearing axis coincides with the second axis 60). According to the embodiment of to FIG. 1a the contact angle 190 has a value α of 60 degrees, but other values α such as 45 degrees are possible.

In the context of this disclosure the term “angular contact bearing” is used to refer to bearings with contact angles 190 different from 0 degrees (purely radial bearing) and 90 degrees (purely axial bearing), whereby the angular contact bearings 70 are configured to bear both radial and axial loads. According to the embodiment of to FIG. 1a the rolling elements 75 in the angular contact bearings 70 are cylindrical, but other types of rolling elements 75 such as spherical ones can also be used.

The two angular contact bearings 70 are preloaded by means of a first nut 100 tightened on an external screw thread 110 on the shaft 50 such that the angular contact bearings 70 sit relatively tight between a first shoulder 120 on the shaft 50 and a second shoulder 130 on the first nut 100. Because the first and second shoulders 120, 130 have inclinations corresponding to the value α of the contact angle 190, the preloading force can be considered to have components both in an axial and in radial directions in relation to the second axis 60. Bearing rings of the angular contact bearings 70 preferably have thin rectangular cross sections and are fully supported on their entire surfaces abutting the first and second shoulders 120, 130, respectively. However, other types of cross sections such as triangular ones can also be used in combination with appropriately directed first and second shoulders 120, 130.

The first housing 20 is formed as a fork comprising two branches 80, and the second housing 30 is arranged rotatable between the two branches 80 by means of a roller bearing 90, in this case a deep groove ball bearing, at each branch 80. Inner bearing rings of the roller bearings 90 are arranged on hinge shafts 140 attached to the second housing 30 by means of screws 150. All the bearing housings are on one side sealed against the exterior of the joint 10 in a watertight manner by means of cover caps 160. Moreover, a shaft sealing 170 and a protection ring 180 are used to seal the shaft 50 against the second housing 30. The total width of the joint 10 in the direction of the first axis 40 is in the order of 50 mm, and is in any case less than 80 mm, such as less than 60 mm. In the context of this disclosure the term “roller bearing” is used to refer to bearings with any type of rolling elements transmitting forces from one bearing raceway to another. According to the embodiment of to FIG. 1a the rolling elements in the roller bearings 90 are spherical, but other types of rolling elements such as cylindrical ones can also be used.

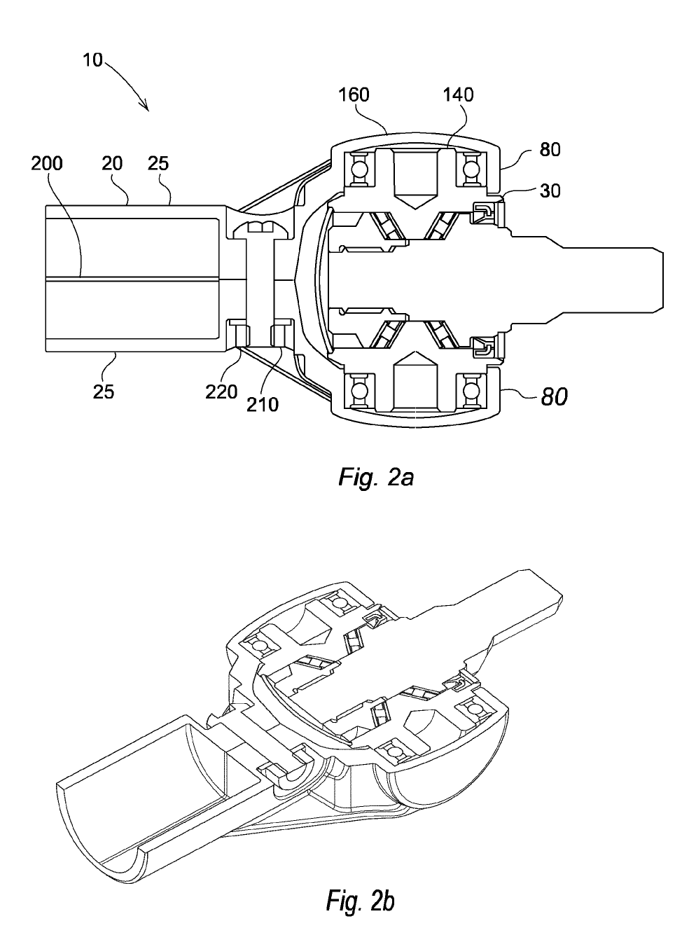

Referring to FIG. 2a, a joint 10 according to one embodiment of the invention comprises a first housing 20 consisting of two individual parts 25 that are identical and configured to be put together. Each of the two branches 80 belongs to a different individual part, and a seam 200 is formed at an interface between the two individual parts. The two individual parts are kept together by means of a bolt 210 and a second nut 220. Main advantages of the embodiment according to FIG. 2a in relation to the one according to FIG. 1a are that it allows the hinge shafts 140 to be integral parts of the second housing 30 (while enabling assembly of the second housing 30 between the two branches 80) and that it allows the cover caps 160 at the roller bearings 90 to be integral parts of the first housing 20. It is to be understood that all the descriptions of components in the context of the embodiment according to FIG. 1a are equally valid for corresponding components of the embodiment according to FIG. 2a.

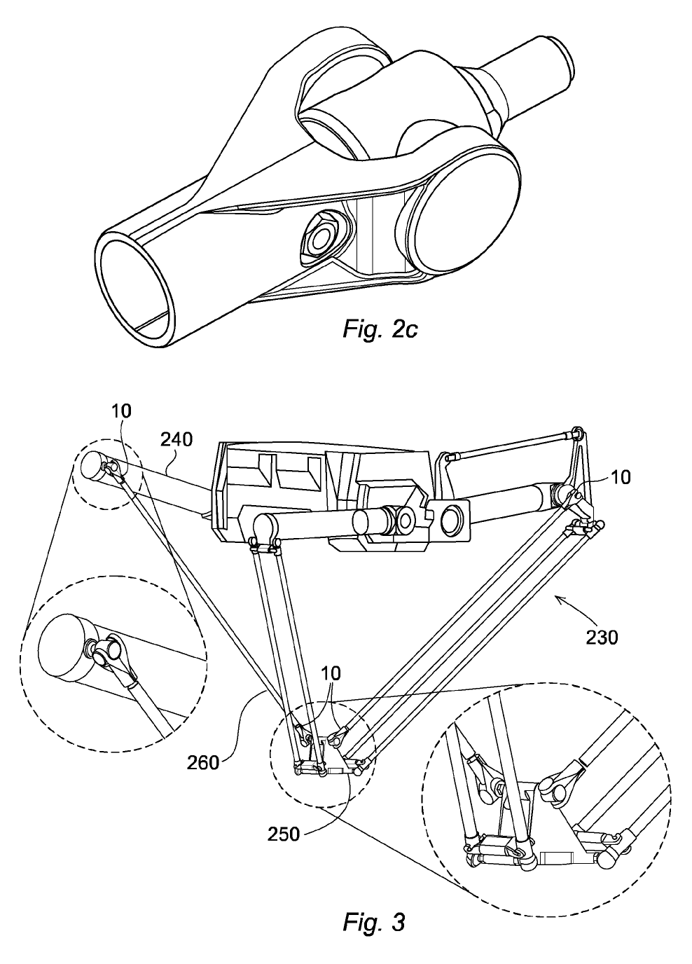

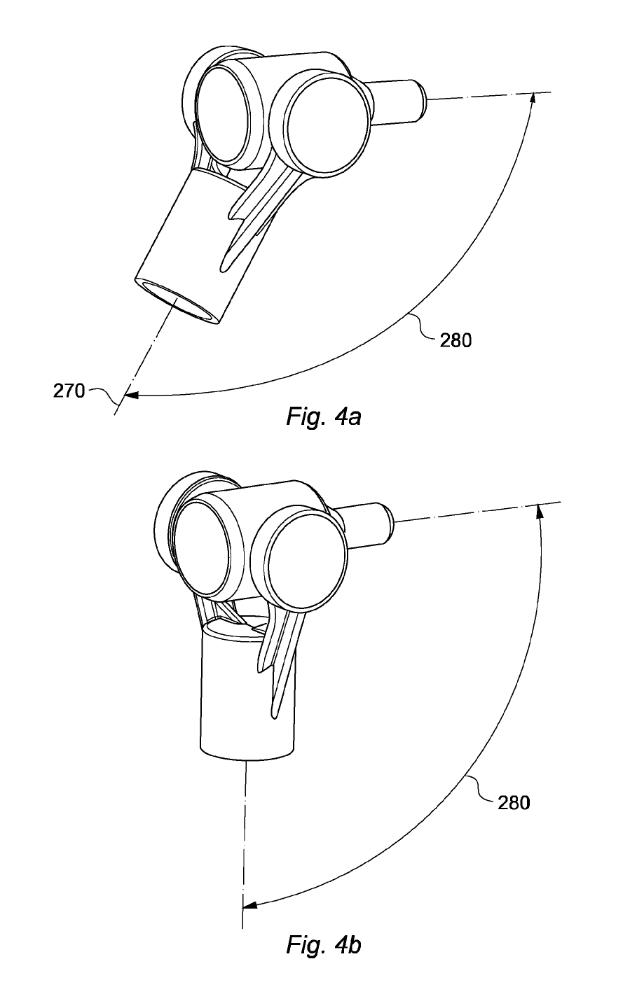

Referring to FIG. 3, an industrial robot 230 in the form of a parallel kinematics robot comprises four joints 10 according to FIG. 2a. The remaining joints of the industrial robot 230 are conventional ones, such as universal ball joints. The actuating forces from robot arms 240 to an end effector 250 are transmitted via rods 260 that are very thin and thereby not configured to carry any considerable bending forces. One major force component affecting on each respective joint 10 is therefore always in a direction of a third axis 270 that coincides with a longitudinal axis of the respective rod 260. By keeping this in mind and studying FIG. 3 together with FIGS. 4a and 4b it is easy to understand that the roller bearings 90 are in all positions of the joints 10 subjected almost solely to radial forces, while the angular contact bearings 70 are subjected to both radial and axial forces in different grades depending on the momentary joint angles 280 of the respective joints 10.

The invention is not limited to the embodiments shown above, but the person skilled in the art may modify them in a plurality of ways within the scope of the invention as defined by the claims.

1.-15. (canceled)

16. A joint for transmitting movements between articulated elements of a parallel kinematics robot, the joint having at least two degrees of freedom and comprising:
a first housing,
a second housing arranged rotatable in relation to the first housing about a first axis,
a shaft arranged rotatable in relation to the second housing about a second axis which coincides with a longitudinal axis of the shaft, the shaft being arranged rotatable in relation to the second housing by at least a first angular contact bearing,
wherein each angular contact bearing includes a plurality of cylindrical rolling elements.

17. The joint according to claim 16, wherein the first axis is perpendicular in relation to the second axis.

18. The joint according to claim 16, wherein the first axis intersects the second axis.

19. The joint according to claim 16, wherein the shaft is arranged rotatable in relation to the second housing by means of a second angular contact bearing configured to bear axial load in opposite direction than the first angular contact bearing.

20. The joint according to claim 16, wherein the first housing is formed as a fork including two branches, and the second housing is arranged rotatable between the two branches by means of a roller bearing at each branch.

21. The joint according to claim 20, wherein each roller bearing is a deep groove ball bearing.

22. The joint according to claim 20, wherein the first housing consists of at least two individual parts that are configured to be put together, each of the two branches belonging to a different individual part.

23. The joint according to claim 20, wherein at least two of the individual parts are identical.

24. The joint according to claim 16, wherein each angular contact bearing is preloaded with a force than has components both in an axial and in radial directions in relation to the second axis.

25. The joint according to claim 24, wherein the preload is achieved by means of a screw thread on the shaft.

26. The joint according to claim 16, wherein the construction of the joint allows the second housing to rotate about the first axis by at least 220 degrees.

27. The joint according to claim 16, wherein the construction of the joint does not limit the rotation of the shaft about the second axis.

28. An industrial robot including a joint according to claim 16.

29. The industrial robot according to claim 28, wherein the industrial robot is a parallel kinematics robot.

30. The joint according to claim 17, wherein the first axis intersects the second axis.

31. The joint according to claim 17, wherein the shaft is arranged rotatable in relation to the second housing by means of a second angular contact bearing configured to bear axial load in opposite direction than the first angular contact bearing.

32. The joint according to claim 18, wherein the shaft is arranged rotatable in relation to the second housing by means of a second angular contact bearing configured to bear axial load in opposite direction than the first angular contact bearing.

33. The joint according to claim 17, wherein the first housing is formed as a fork including two branches, and the second housing is arranged rotatable between the two branches by means of a roller bearing at each branch.

34. The joint according to claim 18, wherein the first housing is formed as a fork including two branches, and the second housing is arranged rotatable between the two branches by means of a roller bearing at each branch.
